(19) United States
(12) Patent Application Publication
(10) Pub. No.: US 2024/0078431 A1
(43) Pub. Date: Mar. 7, 2024

(54) PROMPT-BASED SEQUENTIAL LEARNING

(71) Applicant: NEC Laboratories America, Inc., Princeton, NJ (US)

(72) Inventors: Xuchao Zhang, Elkridge, MD (US); Haifeng Chen, West Windsor, NJ (US); Chang Lu, Jersey City, NJ (US)

(21) Appl. No.: 18/454,262

(22) Filed: Aug. 23, 2023

Related U.S. Application Data
(60) Provisional application No. 63/400,767, filed on Aug. 25, 2022.

(51) Int. Cl. G06N 3/08; G06F 40/40; G06N 3/042; G06N 3/048

(52) U.S. Cl. CPC G06N 3/08; G06F 40/40; G06N 3/042; G06N 3/048

(57) ABSTRACT

Methods and systems for training a language model include retrieving a knowledge sentence, related to an input sentence, from a knowledge base. The input sentence, the knowledge sentence, and a prompt are encoded into an intermediate representation. The intermediate representation is decoded to generate a named entity from the input sentence that is of a type specified by the prompt. A language model is fine-tuned based on the named entity.

### RELATED APPLICATION INFORMATION

This application claims priority to U.S. Patent Application No. 63/400,767, filed on Aug. 25, 2022, incorporated herein by reference in its entirety.

### BACKGROUND

### Technical Field

The present invention relates to natural language processing and, more particularly, to labeling sequential input.

### Description of the Related Art

Natural language processing using machine learning systems relies on having a corpus of labeled training data. While there exist training corpuses for a variety of different domains, the amount of available training data for a highly specific or new domain may be relatively limited. This makes it difficult to train a machine learning model for the new domain directly from the available training data.

### SUMMARY

A method for training a language model includes retrieving a knowledge sentence, related to an input sentence, from a knowledge base. The input sentence, the knowledge sentence, and a prompt are encoded into an intermediate representation. The intermediate representation is decoded to generate a named entity from the input sentence that is of a type specified by the prompt. A language model is fine-tuned based on the named entity.

A system for training a language model includes a hardware processor and a memory that stores a computer program. When executed by the hardware processor, the computer program causes the hardware processor to retrieve a knowledge sentence, related to an input sentence, from a knowledge base, to encode the input sentence, the knowledge sentence, and a prompt into an intermediate representation, to decode the intermediate representation to generate a named entity from the input sentence that is of a type specified by the prompt, and to fine-tune a language model based on the named entity.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing named entity recognition that is enhanced by the use of a prompt and a knowledge base, in accordance with an embodiment of the present invention;

FIG. 2 is block/flow diagram of a method for training a named entity recognition model using the prompt and the knowledge base, in accordance with an embodiment of the present invention;

FIG. 3 is a block/flow diagram of a method for retrieving external knowledge from the knowledge base for use in training, in accordance with an embodiment of the present invention;

FIG. 4 is a block diagram of a computing device that can train a language model and perform named entity recognition, in accordance with an embodiment of the present invention;

FIG. 5 is a diagram of a neural network architecture that can be used to implement part of the named entity recognition system, in accordance with an embodiment of the present invention;

FIG. 6 is a diagram of a deep neural network architecture that can be used to implement part of the named entity recognition system, in accordance with an embodiment of the present invention.

### DETAILED DESCRIPTION OF PREFERRED EMBODIMENTS

Training a machine learning system can be performed using a relatively large training corpus in a first domain, referred to herein as the source domain, and a relatively small training corpus in a second domain, referred to herein as the target domain. The training may be enhanced using knowledge relating to the subject matter of an input, for example by performing a search of a knowledge base using the input to generate contextual information relating to the input. Thus, given a corpus for the target domain in a sequential labeling task, a knowledge-enhanced prompt learning model may be trained to handle the task in a new domain.

An exemplary natural language processing task is named entity recognition, whereby the trained machine learning model accepts a sentence as input and outputs any named entities within the input sentence. For example, proper names of people and places may be identified and output along with a label that identifies the type of entity. Named entity recognition is a task with a variety of applications, such as in question-and-answer systems and dialog systems, as well as in enterprise document analysis applications such as resume scanning and search engine query parsing. The present principles may, for example, by applied to sequence labeling tasks, such as part-of-speech tagging and sequence chunking.

The output of the machine learning model may be further refined by the use of a natural language prompt. For example, the prompt may specify particular types of entities to be identified, or any other appropriate limitation or refinement on the output of the system. The label prompt may be encoded, along with the original input sentence and any related knowledge that has been obtained, to generate an input to a decoder that generates a set of output entities.

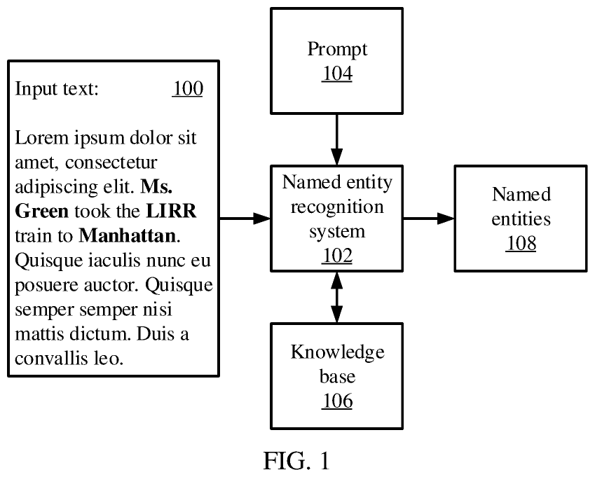

Referring now to FIG. 1, an exemplary natural language processing task is shown. In this case, input text 100 is provided to a named entity recognition system 102. A prompt 104 may also be provided, for example specifying a type of attribute to use to filter the named entities discovered in the input text 100. The named entity recognition system 102 consults a knowledge base to collect contextual information about the input text 100. Based on the input text 100, the prompt 104, and contextual information from the knowledge base 106, the named entity recognition system 102 outputs any named entities that are identified within the input text 100, filtered according to the prompt 104.

In the specific example of FIG. 1, the input text 100 includes certain named entities, illustrated with bold text, including a personal name, “Ms. Green,” an organization's name, “LIRR,” and a location name, “Manhattan.” Each of these named entities has an associated type: person, organization, or location. A given corpus of training data may be labeled, such that each named entity may be associated with one or more such types. However, any corpus will necessarily be limited in the types that are applied to it, reflecting a particular source domain. While there are large corpuses available for training, with many different examples that may be used as input text 100, a given application may look for named entities that have a type which is not represented in such a corpus. The difference between the types of named entities sought by the named entity recognition task reflects a target domain that is different from the source domain. The amount of training data available for the target domain may be substantially smaller than the amount of training data available for the source domain.

For example, whereas the source domain in the example of FIG. 1 includes the types person, organization, and location, a target domain may include a different set of types, such as person, website, and software. A named entity recognition trained solely on training data from the source domain may not recognize named entities in the target domain.

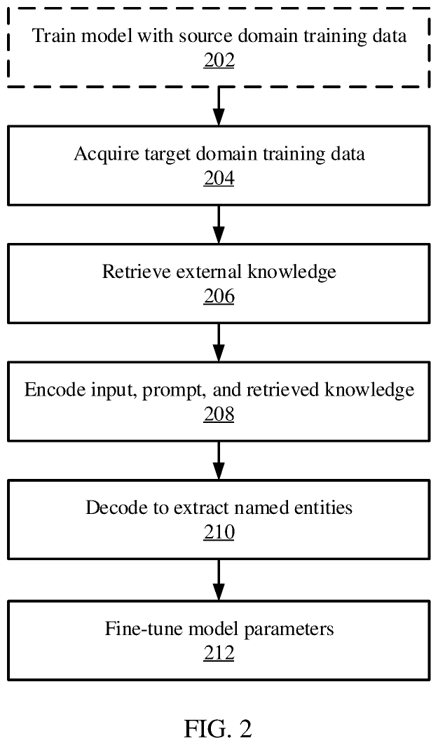

Referring now to FIG. 2, a method of training and using a named entity recognition model is shown. Block 202 beings with an optional step of training a named entity recognition model using a training data corpus in a source domain that has a relatively large number of examples. Block 202 is optional, as a pre-trained model may be used instead. While a pre-trained model may be used, training the model in the source domain for the task can provide superior performance, as the model will already be aligned to the task before fine-tuning.

Block 204 then acquires a relatively small number of examples from the target domain. For example, while there may be thousands of examples available in the source domain, the target domain may have between ten and twenty examples. While there may be some overlap in the label spaces of the source domain and the target domain, in some cases they two label spaces may be completely different.

Block 206 retrieves external knowledge from a knowledge base 106. Useful knowledge may be selected to integrate into the language model. Additional detail on the access of the knowledge base 106 is described in greater detail below. The retrieved external knowledge may be in the form of descriptive sentences. Following the example of FIG. 1 above, the knowledge base 106 may return sentences such as, “The LIRR is an organization,” and, “Manhattan is a location,” to provide useful background information regarding the named entities.

Based on the task and the label space, a prompt 104 may be included as well to further describe the semantics of the task and labels for the language model. Following the example above, the prompt may be a sentence like, “Generate all the entities that are locations.” The prompt 104 may be combined with the retrieved knowledge from block 206 and the input text as an input to an encoder in block 208. The encoder encodes the inputs together and generates an intermediate representation, for example as a vector in a latent space.

The knowledge vector may be aggregated using the equation K=Aggregate(H_{I},Hₖ), where Hₖ is the knowledge vector and H_{I} is the intermediate representation. The prompt vector is used to calculate H_{I}, as above. The prompt may be generated manually, and the prompt sentence is encoded to initialize prompt parameters ϕ.

Block 210 then decodes the intermediate representation to generate an answer. For example, the decoder may generate a set of tokens that represent named entities from the input text 100. In particular, these output tokens may represent a subset of the total number of named entities in the input text, filtered by the prompt 104 and enhanced by the knowledge extracted from the knowledge base 106. The encoder and the decoder may be implemented as transformer models.

Two trainable embedding matrices may be defined as trainable prompt parameters. The attention function of the encoder, with the prompt, may be written as:

$$Attention ( {Q}^{l} , {K}^{l} , {V}^{l} ) = Softmax ( \frac{{{Q}^{l} [ {K}^{l} : {ϕ}_{k}^{l} ]}^{T}}{\sqrt{d}} ) [ {V}^{l} ; {ϕ}_{v}^{l} ]$$

where l refers to the attention layer, Q, K, and V are the query, key, and value parameters of the self-attention layer, respectively, ϕₖ and ϕᵥ are prompt parameters corresponding to K and V, and [ [symbol] ] denotes a concatenation operation. The input sequence representation may be projected to the Q, K and V values. For each ϕᵥ^{l} and ϕₖ^{l}, they may be initialized with the word embedding of a manually defined prompt. The hidden representation H_{I} of the input sentence may be determined using the encoder.

A scaled dot-product attention may be used to aggregate the knowledge sentences and input sentence. The hidden representation Hₖ of the knowledge sentences may be generated using a pre-trained language model, using the last token embedding of each sentence. The input representation H_{I} may be used as a query, with the representation Hₖ of the knowledge sentences being used as the key and value:

$$K = Aggregation ( {H}_{I} , {H}_{k} ) = Softmax ( \frac{{H}_{I} {{W}^{Q} ( {H}_{k} {W}^{K} )}^{T}}{\sqrt{d}} ) {H}_{k} {W}^{V} ∈ {ℝ}^{n \times d}$$

where H_{I} is the representation of the input sentence, Hₖ is the representation of the knowledge sentences, ϕ is the prompt vector, and d is the last dimension size of the matrix HₗW^{Q}.

For each word in the original sentence, an embedding of significant knowledge sentences is determined. The aggregated embedding for the input sentences is the defined as:

Hₑₙ=K+H_{I}

The decoding uses the output of the encoder and previous decoder output tokens to decode a next token. The pre-trained decoder is used to generate the index [symbol] as a softmax of probability of sequence and tag:

p_{seq}=Hₑₙ⊗h_{dec}

p_{tag}=WorkEmbedding(C)⊗h_{dec}

pᵢ=Softmax([p_{seq};p_{tag}])

[symbol]

=argmax(pᵢ)

where h_{dec} is the output of the decoder based on the encoder representation. The index [symbol] is the position of each token in the input sentence, and is used to select tokens from the input sentence. Using the ground truth value pᵢ, a categorical cross-entropy loss may be determined between pᵢ an yᵢ and may be used to fine-tune the parameters of the model in 212.

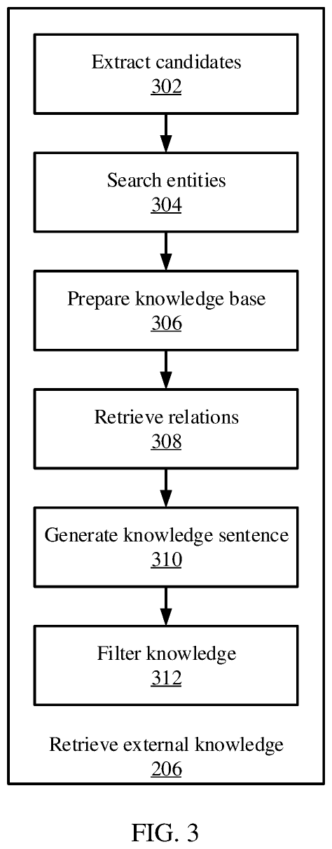

Referring now to FIG. 3, additional information on the retrieval of external knowledge of block 206 is shown. Block 302 uses a sentence parser to retrieve candidate noun phases from the input sentence. Block 304 uses an existing knowledge base to search entries of each noun phrase. For every noun phrase αᵢ, the search returns b entries, together with their scores:

search(αᵢ)=(ε₁,s₁),(ε₂,s₂), . . . ,(ε_{b},s_{b})

where εᵢ and sᵢ represent an i^{th} entry and score, respectively. The scores represent a relevance of the entry to the noun phrase. The entries with the top k scores may be selected to obtain the most relevant entries in the knowledge base.

Block 306 prepares the knowledge base of external knowledge. Any appropriate knowledge base, such as a publicly available encyclopedia, may be used as the source of external knowledge. For example, the knowledge base may include a multilingual knowledge graph, in which encyclopedic knowledge is encoded in the format of entities and relations. Block 308 retrieves relations from the knowledge base, as used in the entity search 304, accepting an entry and relation as input. Following the example of named entity recognition, the input may specify that the “type” relation to determine the type of an entry defined in the knowledge base.

Block 310 generates knowledge sentences, for example choosing samples according to an epistemic uncertainty. The top samples may be selected, for example selecting a percentage according to the scores generated in the entity search 304. The samples with the highest scores may then be selected according to a threshold, for example selecting the top 30% of samples. Entry words (e.g., query words of the knowledge base) and their associated types are selected to produce knowledge sentences that can be processed by language models.

A template for the knowledge sentences may be used, for example of the form, “The <entry> is a <type>.” For each εᵢ and corresponding type τᵢ, the <entry> in the template may be replaced with εᵢ and the <type> in the template may be replaced with τᵢ. The corresponding template may be selected based on grammar to generate the sentence σᵢ. For example, for the relation “Einstein rdf:type Person”, the template may generate the knowledge sentence, “Einstein is a person.”

In some cases, the knowledge base may return entries that are similar to noun phrases. At the sentence level, the returned entries may not be relevant to the input sentence. Therefore, a pretrained language model may be used to further filter relevant knowledge sentences. The encoder may be used to calculate a hidden representation of the input sentence X. For each σᵢ, the decoder may be used to give a score sᵢ′of σᵢ:

sᵢ′=decoder(σᵢ,encoder(X))

A top-k function may be used to select the most relevant k knowledge sentences as the output of the knowledge retrieval.

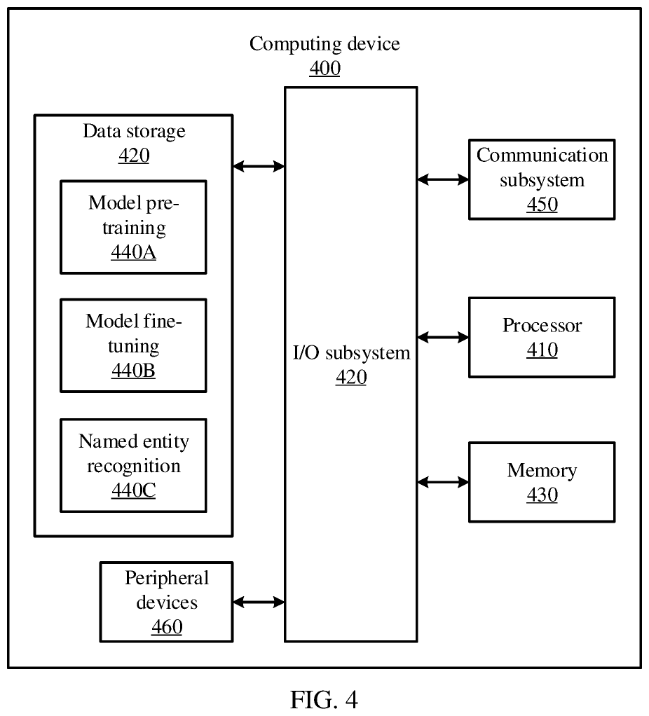

Referring now to FIG. 4, an exemplary computing device 400 is shown, in accordance with an embodiment of the present invention. The computing device 400 is configured to perform named entity recognition.

The computing device 400 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 400 may be embodied as one or more compute sleds, memory sleds, or other racks, sleds, computing chassis, or other components of a physically disaggregated computing device.

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for pre-training a model, 440B for fine-tuning a model, and/or 440C for named entity recognition. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

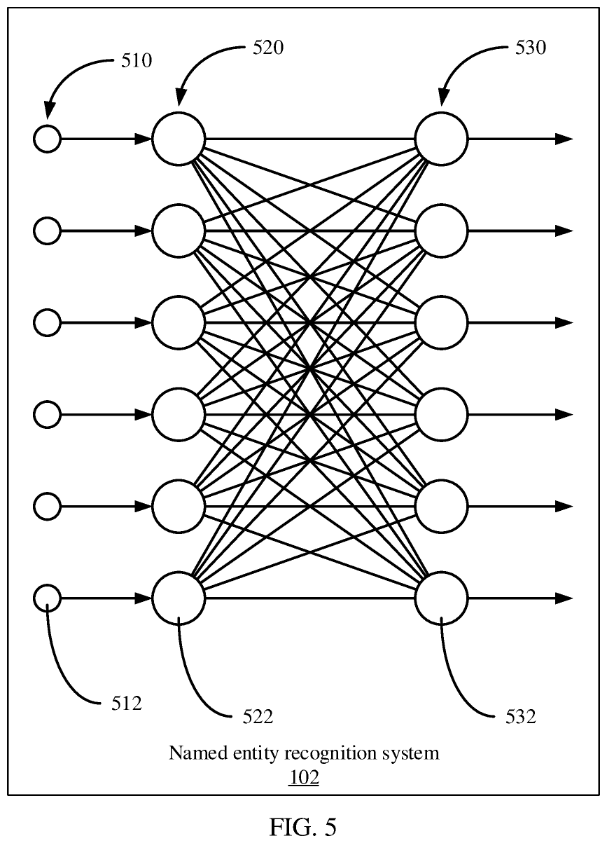

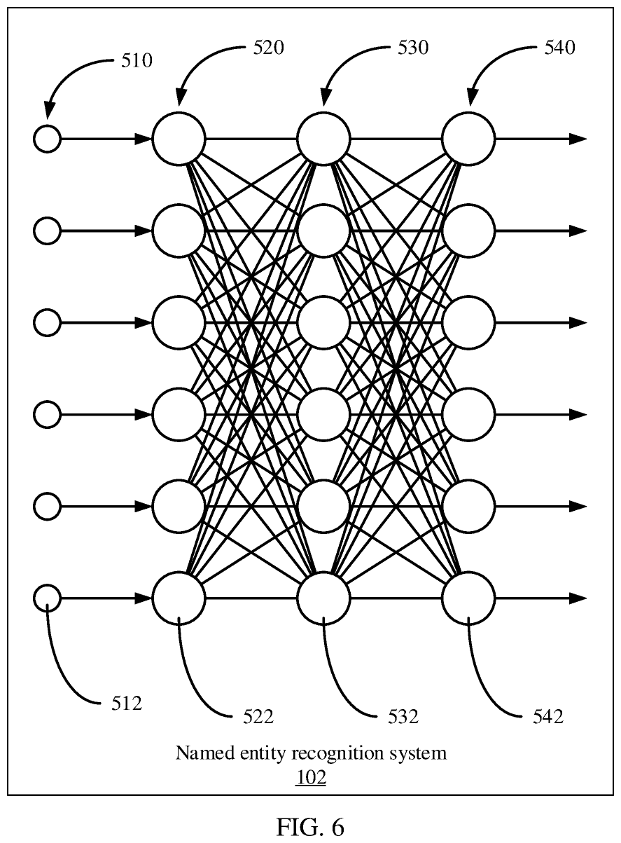

Referring now to FIGS. 5 and 6, exemplary neural network architectures are shown, which may be used to implement parts of the present models, such as the named entity recognition system 102. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a language model, comprising:
retrieving a knowledge sentence, related to an input sentence, from a knowledge base;
encoding the input sentence, the knowledge sentence, and a prompt into an intermediate representation;
decoding the intermediate representation to generate a named entity from the input sentence that is of a type specified by the prompt; and
fine-tuning a language model based on the named entity.

2. The method of claim 1, wherein retrieving the knowledge sentence includes searching a knowledge base for entities in the input sentence.

3. The method of claim 2, wherein retrieving the knowledge sentence further includes retrieving relations from the knowledge base.

4. The method of claim 3, wherein retrieving the knowledge sentence further includes generating a set of knowledge sentences from the entities and the relations and selecting a percentage with a highest relevance to the input sentence.

5. The method of claim 4, wherein the set of knowledges sentences include sentences of the form <entity> is a <type>.

6. The method of claim 2, wherein the knowledge base is a multilingual knowledge graph.

7. The method of claim 1, further comprising pre-training the model with labeled training data from a source domain, wherein the input sentence includes labeled entities from a second domain.

8. The method of claim 1, wherein encoding uses an attention function:
$$Attention ( {Q}^{l} , {K}^{l} , {V}^{l} ) = Softmax ( \frac{{{Q}^{l} [ {K}^{l} : {ϕ}_{k}^{l} ]}^{T}}{\sqrt{d}} ) [ {V}^{l} ; {ϕ}_{v}^{l} ]$$
where l designates an attention layer, Q, K, and V are query, key, and value parameters of the attention layer, respectively, ϕₖ and ϕᵥ are prompt parameters corresponding to K and V, and [ [symbol] ] denotes a concatenation operation, and d is a dimension size.

9. The method of claim 1, wherein the prompt specifies a type of entity to be identified.

10. The method of claim 1, wherein encoding includes aggregating a representation of the input sentence with a representation of the knowledge sentence, based on the prompt.

11. A system for training a language model, comprising:
a hardware processor; and
a memory that stores a computer program which, when executed by the hardware processor, causes the hardware processor to:
retrieve a knowledge sentence, related to an input sentence, from a knowledge base;
encode the input sentence, the knowledge sentence, and a prompt into an intermediate representation;
decode the intermediate representation to generate a named entity from the input sentence that is of a type specified by the prompt; and
fine-tune a language model based on the named entity.

12. The system of claim 11, wherein the computer program causes the hardware processor to search a knowledge base for entities in the input sentence.

13. The system of claim 12, wherein the computer program causes the hardware processor to retrieve relations from the knowledge base.

14. The system of claim 13, wherein the computer program causes the hardware processor to generate a set of knowledge sentences from the entities and the relations and selecting a percentage with a highest relevance to the input sentence.

15. The system of claim 14, wherein the set of knowledges sentences include sentences of the form <entity> is a <type>.

16. The system of claim 12, wherein the knowledge base is a multilingual knowledge graph.

17. The system of claim 11, wherein the computer program causes the hardware processor to pre-train the model with labeled training data from a source domain, wherein the input sentence includes labeled entities from a second domain.

18. The system of claim 11, wherein encoding uses an attention function:
$$Attention ( {Q}^{l} , {K}^{l} , {V}^{l} ) = Softmax ( \frac{{{Q}^{l} [ {K}^{l} : {ϕ}_{k}^{l} ]}^{T}}{\sqrt{d}} ) [ {V}^{l} ; {ϕ}_{v}^{l} ]$$
where l designates an attention layer, Q, K, and V are query, key, and value parameters of the attention layer, respectively, ϕₖ and ϕᵥ are prompt parameters corresponding to K and V, and [ [symbol] ] denotes a concatenation operation, and d is a dimension size.

19. The system of claim 11, wherein the prompt specifies a type of entity to be identified.

20. The system of claim 11, wherein the computer program causes the hardware processor to aggregate a representation of the input sentence with a representation of the knowledge sentence, based on the prompt.
